(19) United States
(12) Patent Application Publication
(10) Pub. No.: US 2020/0059179 A1
(43) Pub. Date: Feb. 20, 2020

(54) SYSTEM AND METHOD FOR ELECTRICITY PRODUCTION FROM PRESSURE REDUCTION OF NATURAL GAS

(71) Applicant: ANAX HOLDINGS, LLC, Santa Monica, CA (US)

(72) Inventor: Andrew Brash Pearson, Glasgow (GB)

(73) Assignee: ANAX HOLDINGS, LLC, Santa Monica, CA (US)

(21) Appl. No.: 16/663,151

(22) Filed: Oct. 24, 2019

Related U.S. Application Data
(63) Continuation-in-part of application No. PCT/US18/30026, filed on Apr. 27, 2018.
Application No. PCT/US18/30026 is a continuation-in-part of application No. PCT/US19/29677, filed on Apr. 29, 2019.
Application No. PCT/US19/29677 is a continuation-in-part of application No. PCT/US19/29674, filed on Apr. 29, 2019.
(60) Provisional application No. 62/490,913, filed on Apr. 27, 2017.
(60) Provisional application No. 62/664,009, filed on Apr. 27, 2018.
(60) Provisional application No. 62/664,021, filed on Apr. 27, 2018.
(60) Provisional application No. 62/664,009, filed on Apr. 27, 2018.
(60) Provisional application No. 62/664,021, filed on Apr. 27, 2018.

(51) Int. Cl. H02P 9/42; H02K 7/18; H02K 11/04; F02C 1/02

(52) U.S. Cl. CPC H02P 9/42; H02K 7/1823; H02P 2101/25; F02C 1/02; H02K 11/046

(57) ABSTRACT

A power generation system having a permanent magnet generator and an electrical conversion system. The electrical conversion system can have an AC/DC converter and a DC/AC inverter. The AC/DC converter can be mounted on the permanent magnet generator within a common enclosure with the permanent magnet generator. One or more DC bus bars can transmit a DC current generated by the AC/DC converter to a second enclosure, which can have a DC/AC inverter to generate AC power.

### CROSS-REFERENCE TO RELATED APPLICATIONS

This application claims the benefit of U.S. Provisional Patent Application No. 62/664,021 filed Apr. 27, 2018, and U.S. Provisional Patent Application No. 62/664,009 filed Apr. 27, 2018, the contents of which are incorporated herein in their entirety.

### BACKGROUND

### Field

The present disclosure relates to the electrical power conversion and transmission for turboexpander generator systems. More specifically, the present disclosure relates to the delivery of AC power at standard domestic power supply frequencies from turboexpander generators operating at high rotational speeds.

### Background

Natural gas is obtained from wells drilled into in rock formations deep underground, where natural gas is found alone and in association with other hydrocarbon fuels such as petroleum and coal deposits. In general, natural gas from such wells is cleaned, typically compressed, and is then distributed by a system of natural gas pipelines to the industrial and residential sites of use of the natural gas as a fuel. Since the natural gas in the distribution pipeline is typically at a higher pressure than the pressure needed at the site of use, a pressure let down station is usually situated between the sites of use and the high pressure pipeline distribution system as a facility where the pressure of the natural gas can be reduced before the natural gas is delivered to where it will be used.

The process of reducing the pressure of the natural gas at a pressure let down station provides an opportunity to recover useful energy without the combustion of the natural gas. It is desirable have an alternative to combustion, since complete combustion produces carbon dioxide a greenhouse gas and incomplete combustion can release methane, also a greenhouse gas, that is a major component of natural gas. From one perspective, the recovery of energy from the pressure differential between the natural gas in the distribution pipeline system and the natural gas downstream of the site of a pressure let down station can be regarded as the recovery of “waste heat,” energy that would otherwise be unavailable for use.

Principle of operation. The energy contained in a gas at a certain pressure and temperature is called the enthalpy (h) and comprises the internal energy (u) plus the product of pressure (p) and volume (V). Thus

h=u+pV (1)

Pressure, volume and temperature (T) are related by the ideal gas laws that state, for example that

pV=mRT (2)

Where m is the mass of gas in the system and R is the universal gas constant, and the definition of an expansion or compression process

pVγ=k (3)

where γ (gamma) is the index of compression (or expansion) and k is a constant value. These useful equations mean that if any two of the three conditions (pressure, volume and temperature) are known then the third can be calculated at that condition and that if one of them changes in accordance with the third equation, as is the case (approximately) in an expander, then the other two can be recalculated for that new condition.

Enthalpy is a useful concept because the form of the energy is not specified, so heat energy, potential energy and work energy are all subject to the same rules and can be treated the same way. For a consistent set of calculations, the enthalpy is given relative to a datum point so care must be taken in comparing different calculations done at different times by different people to ensure that they used the same datum. It is usual to consider the enthalpy per mass of the gas, sometimes called the specific enthalpy, which is measured in BTU per pound, or in the metric system, in kJ per kg.

When the pressure of a gas is reduced, its volume per pound and temperature are altered, and its specific enthalpy changes unless the gas undergoes adiabatic expansion. In adiabatic expansion the gas volume increases and the temperature drops. The reduction of temperature during pressure reduction by a regulating valve at the pressure let down station is an example of adiabatic expansion and is called the Joule-Thompson effect (named after two pioneers of thermodynamics, James Joule and Lord Kelvin, born William Thompson). However, the lack of a specific enthalpy change would result in no useful work output.

In a standard pressure let down station, the Joule-Thompson effect causes the outlet gas to cool, typically by about 5° F. per 100 psi pressure drop. For example, if the pressure of natural gas is reduced from 930 psig to 120 psig, a 810 psi (55.8 Bar) pressure drop, the gas might drop from an inlet temperature of 60° F. (15.6° C.) to about 9.4° F. (−12.6° C.). Natural gas at a temperature of 9.4° F. (−12.6° C.) is too cold for onward transmission, so pressure let down stations typically incorporate some form of heating, often just taking a small portion of the natural gas and burning it to heat a water bath which is used to warm up the gas flow either before or after expansion.

Energy recovered during a pressure let down process needs to be delivered in a format compatible with downstream power use. In many applications, AC power needs to be delivered as an electrical power output consistent with the voltage and frequency characteristics of the local electricity grid, which typically operates at 50-60 Hz.

The invention is directed to these and other important needs. Solutions are needed that recover the energy available due to the pressure differential between the inlet and the outlet of the pressure let down station, and without causing a reduction in temperature that would make the natural gas too cold for onward transmission to the site of its use.

### SUMMARY

In a traditional turboexpander generator, the rotation of a shaft assembly driven by torque imparted by expanding gas in a turboexpander unit produces an electrical current via the interaction of permanent magnets in the rotor shaft and the surrounding stator. In high-performance turboexpander generators, the rotor shafts can rotate at speeds of over 20,000 rpm, leading to the generation of AC electricity with high frequencies, such as over about 650 Hz or over about 750 Hz. In traditional generator systems, the produced electrical current is transferred through a power feed-through to make electrical connections with a terminal box that contains systems, in some instances an inverter where the electrical current is first rectified to DC then converted to AC, to convert the high-frequency AC power into an electrical power output consistent with the voltage and frequency characteristics of the local electricity grid, which typically operates at 50-60 Hz.

It has been observed that electrical cabling for traditional power feed-through lines suffers from inefficiencies, difficulties in production, and lack of robustness for typical operating environments. Skin effect in the transmission line for electrical power at frequencies above about 650 Hz or above about 750 Hz necessitates the use of multiple, such as about 12, smaller diameter cables for the power feed-through. Such power feed-through lines formed from multiple smaller internal cables are relatively difficult and expensive to manufacture.

An improved traditional turboexpander generator is provided in the present disclosure. In some implementations, the high-frequency AC current created by the permanent magnet generator is converted to DC current within the turboexpander enclosure. The DC current is transferred via a DC-DC bus bar to a second enclosure, which may be a controller enclosure or terminal box. Skin effect makes the use of a bus bar for AC current transfer impractical at the frequency ranges in high-performance turboexpander generators.

The present disclosure provides for turboexpander generator systems comprising a permanent magnet generator and an electrical conversion system. The electrical conversion system can comprise an AC/DC converter. The AC/DC converter can be mounted on the permanent magnet generator within a common enclosure with the permanent magnet generator. The AC/DC converter can be a dual rectifier stack. One or more DC bus bars can be provided to transmit DC current generated by the AC/DC converter to a second enclosure. The second enclosure can be a controller enclosure or a terminal box. A DC/AC inverter can be provided within the second enclosure. The DC/AC inverter can be configured to generate AC current appropriate for transmission to a utility grid. The AC current can be three-phase 60 Hz AC. In certain implementations, the electrical conversion system can be configured for 275 kVA power from the permanent magnet generator. In some implementations, the generated current from the second enclosure can be 480 Vrms L-L.

The present disclosure provides methods of generating electrical power. The methods can comprise generating a first AC electrical current from a permanent magnet generator, transmitting the first AC electrical current to an AC/DC converter contained within a common enclosure with the permanent magnet generator, converting the first AC electrical current to a DC electrical current with the AC/DC converter, transmitting the DC electrical current via one or more DC bus bars to a second enclosure, inverting the DC electrical current with an inverter located within the second enclosure to generate a second AC electrical current. In some implementations, the methods can further comprise transmitting the second AC electrical current from the second enclosure to a utility grid. In certain implementations, the first AC electrical current can have about 275 kVA apparent power. In some implementations, the second AC electrical current can be generated as 480 Vrms L-L 60 Hz current.

The above described and other features are exemplified by the following figures and detailed description.

### BRIEF DESCRIPTION OF THE DRAWINGS

The foregoing and other features and advantages will be apparent from the following more particular description of exemplary implementations of the disclosure, as illustrated in the accompanying drawings, in which like reference characters refer to the same parts throughout the different views. The drawings are not necessarily to scale, emphasis instead being placed upon illustrating the principles of the disclosure.

FIG. 1A is a schematic diagram of an implementation of the disclosed system 10, showing the path of a process gas from a process gas inlet 50 passing through a first heat exchanger 410, a first stage turboexpander 110, a second heat exchanger 420, a second stage turboexpander 210, to a process gas outlet 60, where the first stage turboexpander 110 and the second stage turboexpander 210 are operatively coupled to a generator 310 by a shaft assembly 340, wherein, in use, the flow of the process gas through the system 10 from the process gas inlet 50 to the process gas outlet 60 produces an electrical output 80.

FIG. 1B is a block diagram of an implementation of a system controller 500, showing the system controller 500 operatively connected to a first stage turboexpander 110, a second stage turboexpander 210, a generator 310, an electrical conversion system 380, a first heat exchanger 410, a second heat exchanger 420, a valve system 600 and a sensor system 700.

FIG. 2 is a schematic diagram showing aspects of an implementation of the disclosed systems and methods.

FIG. 3 is a schematic diagram showing aspects of an implementation of the disclosed systems and methods.

FIG. 4 is a schematic diagram showing aspects of an implementation of the disclosed systems and methods.

While the specification concludes with claims defining the features of the present disclosure that are regarded as novel, it is believed that the present disclosure's teachings will be better understood from a consideration of the following description in conjunction with the appendices, figures, in which like reference numerals are carried forward. All descriptions and callouts in the Figures are hereby incorporated by this reference as if fully set forth herein. The failure to number an element in a figure is not intended to waive any rights, and unnumbered references may also be identified by alpha characters in the Figures.

### DETAILED DESCRIPTION

As used herein, a “turboexpander” is a radial or axial flow turbine through which a relatively high pressure gas is expanded to produce work.

As used herein, “working fluid,” “process gas,” or “pipeline natural gas” refers to natural gas that has been processed and transported in a natural gas distribution pipeline system and which is available for use by the disclosed system and apparatus. Typically, certain components of the gas that is obtained from the wellhead are removed before the natural gas is introduced into a pipeline system. Examples of the typical chemical composition of pipeline natural gas are provided in Table 1, below.

As used herein, “secondary fluid,” or “heat-transfer fluid” refers to a fluid that is used to heat or cool the process gas or the control electronics. In certain implementations, the secondary fluid is supplied to a heat exchanger to heat the process gas. In certain implementations, the secondary fluid is water or an aqueous solution. In certain implementations, the secondary fluid can be an aqueous solution of an antifreeze additive, such as propylene glycol, ethylene glycol, glycerol, or combinations thereof. In some implementations, a heat-transfer fluid can be provided for use in heat exchangers as part of a heating circuit and can be any fluid suitable for transferring heat to a process gas, including but not limited to oils and aqueous solutions. In certain implementations, the heat-transfer fluid can be a dielectric fluid, including but not limited to one or more perfluorinated carbons, including but not limited to FLUORINERT™ (3M Company, St. Paul, Minn.), synthetic hydrocarbons, including but not limited to polyalphaolefins (PAO), or combinations thereof. In some implementations, two distinct heat-transfer fluid circuits are provided, with a first heat-transfer fluid circuit provided for cooling the control electronics and a second heat-transfer fluid circuit provided for heating the process gas. In some implementations, heat that is removed from the control electronics can be used in the heating of the process gas by transferring heat between the first and second heat-transfer circuits.

An apparatus is disclosed comprising a process gas system inlet, a process gas system outlet, at least two turboexpanders (a centrifugal or axial flow turbine through which a high pressure process gas is expanded to produce work), and at least one electrical generator operatively coupled to the at least two turboexpanders wherein electrical energy is produced by using the pressure difference between the process gas system inlet and the process gas system outlet. In certain implementations the process gas is natural gas in a natural gas distribution pipeline system. In some implementations, an implementation of the disclosed system is placed at a site between a high pressure location in a natural gas distribution pipeline and a lower pressure location, such as a pressure let down station (also termed a “city gate” station), in order to recover energy from the reduction in pressure required to provide the natural gas at a pressure suitable for consumers.

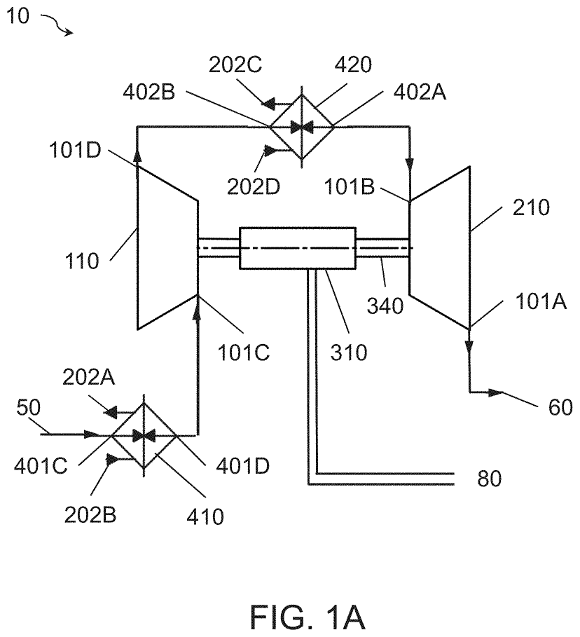

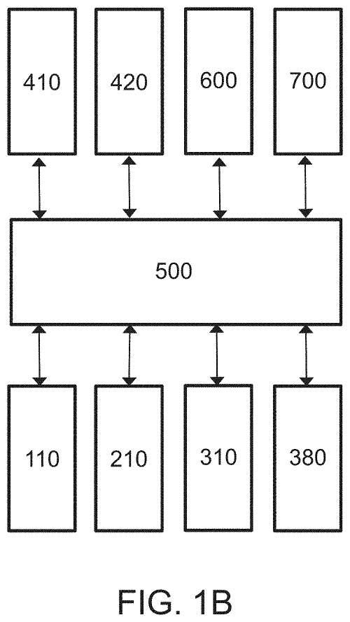

FIG. 1A is a schematic diagram of an implementation of the disclosed system 10, showing the path of a process gas from a process gas inlet 50 passing through a first heat exchanger 410, a first stage turboexpander 110, a second heat exchanger 420; a second stage turboexpander 210, to a process gas outlet 60, where the first stage turboexpander 110 and the second stage turboexpander 210 are operatively coupled to a generator 310 by a shaft assembly 340, wherein, in use, the flow of the process gas through the system 10 from the process gas inlet 50 to the process gas outlet 60 produces an electrical output 80, which is routed to an electrical conversion system 380 (not shown in FIG. 1A) described more fully elsewhere herein.

Referring to FIG. 1A, the process gas enters the process gas inlet 401C of the first heat exchanger 410 acting as a preheater to warm the process gas using heat provided by a secondary fluid flowing from the secondary fluid inlet 202B to the secondary fluid outlet 202A of the first heat exchanger 410. A suitable secondary fluid is an aqueous solution. In certain implementations, the secondary fluid comprises propylene glycol. In some implementations, the secondary fluid is a 30% aqueous solution of propylene glycol.

The process gas flows from the process gas outlet 401D of the first heat exchanger 410 to the process gas inlet 101C of the first stage turboexpander 110. The flow rate and pressure of the process gas are controlled in the disclosed system by valves and regulators in the system upstream of the process gas inlet 401C by structures and methods known to one of skill in the art. The temperature, flow rate and pressure of the process gas are further adjusted by the first heat exchanger 410.

As shown in FIG. 1A, the process gas leaves the first stage turboexpander 110 though the process gas outlet 101D and flows to the process gas inlet 402B of the second heat exchanger 420 that act as an interheater to warm the process gas between the first stage turboexpander 110 and the second stage turboexpander 210 in order to adjust the temperature, flow rate and pressure of the process gas. The process gas entering the process gas inlet 402B of the second heat exchanger 420 is warmed by heat provided by a secondary fluid flowing from the secondary fluid inlet 202D to the secondary fluid outlet 202C of the second heat exchanger 420. A suitable secondary fluid is an aqueous solution. In certain implementations, the secondary fluid comprises propylene glycol. In some implementations, the secondary fluid is a 30% aqueous solution of propylene glycol.

The process gas flows from the process gas outlet 402A of the second heat exchanger 420 to the process gas inlet 101B of the second stage turboexpander 210. Upon exiting the process gas outlet 101A of the second stage turboexpander 210, the process gas flows to the system process gas outlet 60.

The generator 310 can coupled to a first stage turbine shaft of the first stage turboexpander 110 and a second stage turbine shaft of the second stage turboexpander 210 by a shaft assembly. In use, the rotation of the shaft assembly and the interaction of permanent magnets and a stator produces an electrical current that flows through the electrical power output 80.

A torque can be imparted on the shaft assembly by the expanding gas in the one or more turboexpanders and the torque can be converted to electricity by the electrical generator. The electrical power output 80 from the turboexpander and the electrical generator can pass to an inverter where it is first rectified to DC then converted to AC at a voltage and frequency to be consistent with the characteristics of the local electricity grid. In some implementations, the electrical generator can be a permanent magnet generator. In certain implementations, the methods can further comprise sensing an operational characteristic using at least one sensor selected from the group consisting of a sensor that is configured to detect a flow rate of the process gas, a sensor that is configured to detect a pressure of the process gas, and a sensor that is configured to detect a temperature of the process gas. In further implementations, the methods can further comprise sensing an operational characteristic using at least one sensor selected from the group consisting of a sensor that is configured to detect a flow rate of the heat-transfer fluid, a sensor that is configured to detect the pressure of the heat-transfer fluid, and a sensor that is configured to detect the temperature of the heat-transfer fluid.

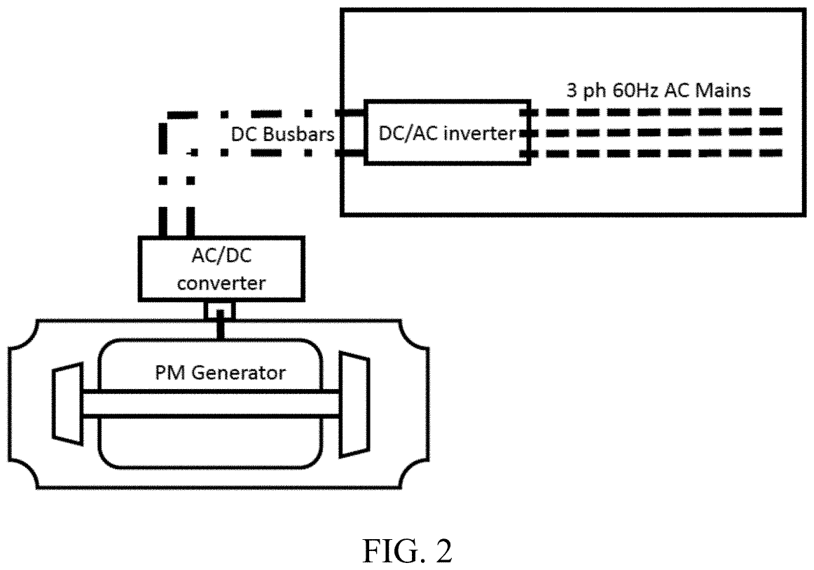

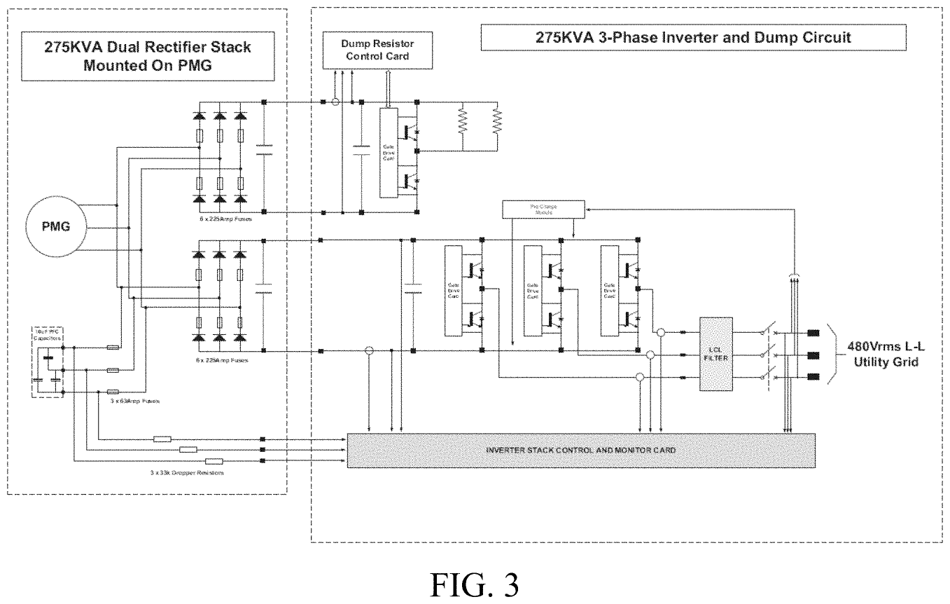

In some implementations, the electrical output 80 can converted to local electricity grid AC voltage, as shown schematically in FIGS. 2-4 and described elsewhere herein. The approach shown schematically in FIGS. 3-5 can be applied to the systems shown in FIGS. 1A-1B and described herein.

The following non-limiting examples further illustrate the various implementations described herein.

### WORKING EXAMPLES

In some implementations, a turboexpander and generator unit has a two stage process gas expander, each stage including a turboexpander and a heat exchanger. High pressure (HP) process gas is first heated to increase the process gas volume and maintain the temperature inside the expander. The heated HP process gas then passes to the first stage turboexpander where it imparts a torque on the common shaft as it expands through the turbine. The process gas then leaves the first stage turboexpander at an inter-stage pressure lower than the pressure at the entry to the first stage turboexpander and is heated again. This second heating further increases the process gas volume, maintains the temperature inside the turboexpander and generator unit and ensures the process gas leaving the second stage turboexpander is not too cold. Finally, the process gas flows through the second stage turboexpander and imparts a torque on the common shaft as the process gas expands through the turbine.

The torque imparted on the common shaft by the expanding gas is converted to electricity by the permanent magnet generator. The electrical power output from the turboexpander and generator unit passes to the inverter where it is first rectified to DC then converted to AC at a voltage and frequency to be consistent with the characteristics of the local electricity grid.

### Example 1

### Turboexpander and Generator Unit

An implementation of the disclosed turboexpander and generator unit and associated system is produced as described above and as illustrated in FIGS. 1A and 1B.

In certain implementations, the turboexpander turbines are configured to operate at a speed of about 20,000 to about 25,000 rpm. In certain implementations, the turboexpander turbines are configured to operate at a speed of about 21,500 to about 24,000 rpm. In some implementations, the turboexpander turbines are designed for a speed of about 22,500 rpm, and an inlet gas temperature of about 328° K (54.85° C., 130° F.). In exemplary implementations, the design pressure ratios are as summarized in Table 2, below.

TABLE 2

| | System Inlet | System Outlet | |
|---|---|---|---|
| System Power | Pressure, | Pressure, PSI | |
| Output, kW | PSI (Bar) | (Bar) | Pressure Ratio |
| 250 | 754 (52) | 465.6 (32.1) | 1.62 |

| | | Outlet | |
|---|---|---|---|
| | Inlet Pressure, | Pressure, | |
| 1^{st} Stage | PSI (Bar) | PSI (Bar) | Pressure Ratio |
| | 754 (52) | 594.7 (41) | 1.27 |
| | | Outlet | |
| | Inlet Pressure, | Pressure, | |
| 2^{nd} Stage | PSI (Bar) | PSI (Bar) | Pressure Ratio |
| | 591.8 (40.8) | 465.6 (32.1) | 1.27 |

The temperature of the process gas at the inlet of the first stage turboexpander and the temperature of the process gas at the inlet of the second stage turboexpander is maintained by using a first heat exchanger and a second heat exchanger, respectively, wherein the first heat exchanger and the second heat exchanger transfer heat from a secondary fluid, such as a 30% aqueous solution of propylene glycol, to the primary fluid or process gas, the natural gas. In certain implementations, the pressure of the process gas at the system inlet is about 754 psi (52 Bar), the pressure of the process gas at the system outlet is about 465.6 psi (32.1 Bar), and the system pressure ratio is 1.62. In certain implementations, the pressure of the process gas at the first stage inlet (i.e., the inlet of the first stage turboexpander) is about 750 psi (51.7 Bar), the pressure of the process gas at the first stage outlet (i.e., the outlet of the first stage turboexpander) is about 594.7 psi (41 Bar), and the first stage pressure ratio is 1.27. In certain implementations, the pressure of the process gas at the second stage inlet (i.e., the inlet of the second stage turboexpander) is about 591.8 psi (40.8 Bar), the pressure of the process gas at the second stage outlet (i.e., the outlet of the second stage turboexpander) is about 465.6 psi (32.1 Bar), and the second stage pressure ratio is 1.27.

In general, implementations of the disclosed turboexpander and generator unit and associated system operate with a flow rate of process gas of about 4 kg/sec (12,036 scfm, 528 lb/min) to about 7.5 kg/sec (22,568 scfm, 990 lb/min). In certain implementations, the disclosed turboexpander and generator unit and associated system operate with a flow rate of process gas of about 4.5 kg/sec (13,541 scfm, 594 lb/min) to about 6.5 kg/sec (19,559 scfm, 858 lb/min). In certain implementations, the disclosed turboexpander and generator unit and associated system configured to the range of conditions exemplified by the values summarized in Table 2, above, operates with a flow rate of process gas of about 5 kg/sec (15,045 scfm, 660 lb/min) to about 6 kg/sec (18,054 scfm, 792 lb/min).

In certain implementations, the disclosed turboexpander and generator unit and associated system configured to the range of conditions operating in a range of conditions exemplified by the values summarized in Table 2, above, can produce an electrical power output of about 225 to about 275 kw, more preferably about 238 to about 263 kW, and typically about 250 kW. In certain implementations, the disclosed turboexpander and generator unit and associated system configured to the range of conditions operating in a range of conditions exemplified by the values summarized in Table 2, above, can produce an electrical power output of about 250 kW.

### Example 2

### Deployable Turboexpander and Generator Unit and Associated System

An exemplary implementation of a turboexpander and generator unit, shown schematically in FIG. 1B, can be configured with related components in a readily transportable turn-key system having components including a controller system 500 operatively connected to a first stage turboexpander 110, a second stage turboexpander 210, a generator 310, an electrical conversion system 380, a first heat exchanger 410, a second heat exchanger 420, a valve system 600 and a sensor system 700 mounted in a frame comprising steel or a material having similar characteristics. The system is pre-configured with piping and wiring, and requires only connection to sources of natural gas, instrument grade compressed air, warm water and electricity. Typically, the required electrical supply to the assembly is three phase 480 volts, 60 Hz. Typically, the frame is configured for commercial containerized transportation.

In certain implementations of the deployable turboexpander and generator unit and associated system, the control electronics are contained in a purged cabinet and at least one panel that houses the control electronics is cooled by a heat exchanger system. In certain implementations, the control electronics are mounted in a control panel that is cooled by water or an aqueous solution. In certain implementations, the control panel is cooled by the secondary fluid, and waste heat extracted by cooling the control electronics can be supplied to the first heat exchanger 410 and the second heat exchanger 420 as a contribution to heating the process gas.

Typically, the electrical supply to the control panel is single phase 120 volts, 60 Hz. In certain implementations, the control electronics include a programmable logic controller. In certain implementations, the control electronics include a computer comprising a microprocessor, a visual display, nonvolatile memory, RAM memory, and at least one user input device selected from a touch screen, a keypad, a keyboard, a mouse, a touch pad, track pad and a track ball. In certain implementations, the computer is connected to a local network by ethernet or a wireless connection, and to the Internet.

In some implementations, the electrical conversion system 380 can be implemented as shown in FIGS. 2-4. The generator 310 (labeled “PM Generator” or “PMG” in FIGS. 2-3) can provide electrical output that connects to an AC/DC converter that is part of the electrical conversion system 380. The AC/DC converter can be a dual rectifier stack that is mounted on the generator 310, as shown in FIG. 3 (dashed box on left-hand side of FIG. 3). DC current generated by the AC/DC converter is transmitted via DC bus bars to a second enclosure (dashed box on right-hand side of FIG. 3), which may be a controller enclosure or terminal box. A DC/AC inverter can be provided within the second enclosure, which generates AC current appropriate for transmission to a utility grid. In some implementations, the AC current can be three-phase 60 Hz AC. In certain implementations, the electrical conversion system can be configured for 275 kVA power from the PMG. In some implementations, the generated current from the second enclosure can be 480 Vrms L-L.

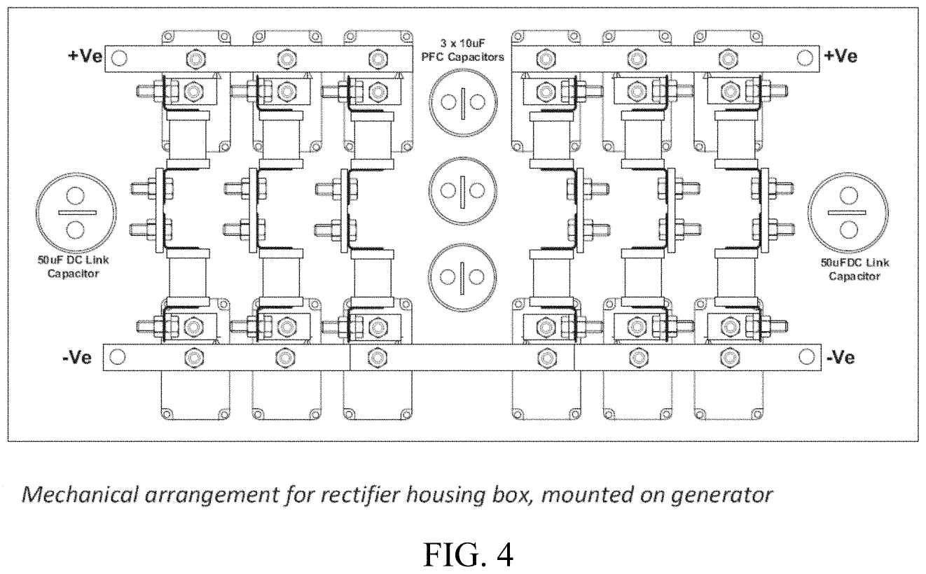

FIG. 4 shows aspects of an implementation of the AC/DC converter of FIGS. 2-3. Two positive bus bars (+Ve) & one negative bus bar (−Ve) are provided for DC power transmission to the second enclosure for inversion to AC power.

While the disclosure has been described with reference to exemplary implementations, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular implementation disclosed as the best mode contemplated for carrying out this disclosure, but that the disclosure will include all implementations falling within the scope of the appended claims.

1. A turboexpander generator system comprising:
a permanent magnet generator, and
an electrical conversion system.

2. The turboexpander generator system of claim 1, wherein:
the electrical conversion system comprises an AC/DC converter and a DC/AC inverter.

3. The turboexpander generator system of claim 2, wherein:
the AC/DC converter is mounted on the permanent magnet generator within a common enclosure with the permanent magnet generator.

4. The turboexpander generator system of claim 2, wherein:
the AC/DC converter comprises a dual rectifier stack.

5. The turboexpander generator system of claim 2, further comprising:
one or more DC bus bars configured to transmit a DC current generated by the AC/DC converter to a second enclosure.

6. The turboexpander generator system of claim 5, wherein:
the second enclosure is a controller enclosure or a terminal box.

7. The turboexpander generator system of claim 6, wherein:
the DC/AC inverter is provided within the second enclosure.

8. The turboexpander generator system of claim 2, wherein:
the DC/AC inverter is configured to generate an AC current appropriate for transmission to a utility grid.

9. The turboexpander generator system of claim 2, wherein:
the DC/AC inverter is configured to generate three-phase 60 Hz AC.

10. The turboexpander generator system of claim 1, wherein:
the electrical conversion system is configured for 275 kVA apparent power from the permanent magnet generator.

11. The turboexpander generator system of claim 1, wherein:
the DC/AC converter is configured to generate current as three-phase 480 Vrms L-L 60 Hz current.

12. A method of generating electrical power, the method comprising:
generating a first AC electrical current from a permanent magnet generator,
transmitting the first AC electrical current to an AC/DC converter contained within a common enclosure with the permanent magnet generator,
converting the first AC electrical current to a DC electrical current with the AC/DC converter,
transmitting the DC electrical current via one or more DC bus bars to a second enclosure, and
inverting the DC electrical current with an inverter located within the second enclosure to generate a second AC electrical current.

13. The method of claim 12, further comprising:
transmitting the second AC electrical current from the second enclosure to a utility grid.

14. The method of claim 12, wherein the first AC electrical current has about 275 kVA apparent power.

15. The method of claim 12, wherein the second AC electrical current is generated as 480 Vrms L-L 60 Hz current.
